(19) United States
(12) Patent Application Publication
(10) Pub. No.: US 2007/0095432 A1
(43) Pub. Date: May 3, 2007

(54) Fluxing compositions containing benzotriazoles

(75) Inventor: Osama M. Musa, Hillsborough, NJ (US)

Correspondence Address: National Starch and Chemical, 10 Finderne Avenue, Bridgewater, NJ, 08807, US

(73) Assignee: National Starch and Chemical Investment Holding Corporation

(21) Appl. No.: 11/265,577

(22) Filed: Nov. 2, 2005

(51) Int. Cl. B23K 35/362

(52) U.S. Cl. 148/23

(57) ABSTRACT

A fluxing composition comprises a fluxing agent, in which the fluxing agent is a benzotriazole or a benzotriazole adduct. The adduct contains a benzotriazole segment and a segment with a curable and polymerizable functionality.

### FIELD OF THE INVENTION

This invention relates to fluxing compositions containing benzotriazole compounds and their application in electronic packaging, particularly within no-flow underfill compositions and pre-applied wafer level underfill for flip-chip based semiconductor packages and electronic assemblies. These compositions also have application for refluxing the solder during solder reflow prior to a capillary underfill process.

### BACKGROUND OF THE INVENTION

An increasingly important method for attaching an integrated circuit onto a substrate in semiconductor packaging operations is the so-called flip-chip technology. In flip-chip technology, the active side of the semiconductor die is bumped with metallic solder balls and flipped so that the solder balls can be aligned and placed in contact with corresponding electrical terminals on the substrate. Electrical connection is realized when the solder is reflowed to form metallurgical joints with the substrates. The coefficients of thermal expansion (CTE) of the semiconductor die, solder, and substrate are dissimilar and this mismatch stresses the solder joints, which ultimately can lead to failure of the semiconductor package.

Organic materials, often filled with organic or inorganic fillers or spacers, are used to underfill the gap between the die and the substrate to offset the CTE mismatch and to provide enforcement to the solder joints. Such underfill materials can be applied through a capillary effect, by dispensing the material along the edges of the die-substrate assembly after solder reflow and lefting the material flow into the gap between the die and substrate. The underfill is then cured, typically by the application of heat.

In an alternative process, an underfill material is pre-applied onto a solder bumped semiconductor wafer, either through printing if the material is a paste, or through lamination if the material is a film. The wafer is singulated into dies and an individual die subsequently bonded onto the substrate during solder reflow, typically with the assistance of temperature and pressure, which also cures the underfill material.

In another process, known as no-flow, a substrate is pre-dispensed with an underfill material, a flip-chip is placed on top of the underfill, and, typically with the assistance of temperature and pressure, the solder is reflowed to realize the interconnection between the die and substrate. These conditions may cure the underfill material, although sometimes an additional cure step is necessary. The reflow process is typically accomplished on thermal compression bonding equipment, within a time period that can be as short as a few seconds.

In all three of these underfill operations, the solder is fluxed either before or during the reflow operation to remove any metal oxides present, inasmuch the presence of metal oxides hinders reflow of the solder, wetting of the substrate by the solder, and electrical connection. For capillary flow operations, fluxing and removal of flux residues is conducted before the addition of the capillary flow underfill. For the no-flow and pre-applied underfill operations, the fluxing agent typically is added to the underfill material.

Many current no-flow underfill resins are based on epoxy chemistry, which achieve solder fluxing by using carboxylic acids or anhydrides. Organic alcohols are sometimes used as accelerators, since they can react with anhydrides to form carboxylic acids, which in turn flux the solder. The carboxylic acids from the anhydrides are volatile during the thermal compression bonding process, and may cause corrosion of the semiconductor packages.

Moreover, anhydride based fluxing agents are not suitable for chemistries that are sensitive to acidic species, such as, cyanate ester based underfill resins. The more reactive anhydrides are too aggressive, causing the resin monomers and oligomers to advance, leading to short resin pot life and voiding during curing. The voiding can negatively impact the interconnections between the solder balls and substrates, causing short circuits and joint failure.

### BRIEF DESCRIPTION OF THE DRAWINGS

FIGS. 1 and 2 show the fluxing of adducts 54 and 55 with the epoxy on Ni/Au coupons.

### SUMMARY OF THE INVENTION

This invention is a fluxing composition comprising a fluxing agent, in which the fluxing agent is a 2-(2-hydroxyphenyl)benzotriazole or a 2-(2-hydroxyphenyl)benzotriazole adduct.

2-(2-Hydroxyphenyl)benzotriazole has the structure

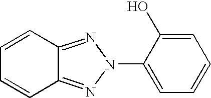

in which additional hydroxyl groups may be present in the 3, 4, 5, or 6 position of the 2-hydroxyphenyl ring, or may be linked to the 2-hydroxyphenyl ring through an aliphatic group, such as in the compound 3-(2H-benzotri-azole-2-yl)-4-hydroxyphenethyl alcohol shown here: 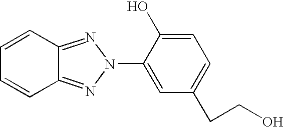
which is available as a fine white powder from Ciba as Tinuvin R 600, later referred to Adduct 55.

2-(2-Hydroxyphenyl)benzotriazole adducts, for the purpose of this specification and the claims, are compounds that contain two chemistry segments: (1) a 2-(2-hydroxyphenyl)benzotriazole segment, which may contain additional hydroxyl groups in the 3, 4, 5, or 6 position of the 2-hydroxyphenyl ring, and (2) a segment that contains electron donor, electron acceptor, epoxy, or acetyl acetonate functionality.

As used herein, the word “benzotriazole” will be deemed to mean 2-(2-hydroxyphenyl)benzotriazole compounds and 2-(2-hydroxyphenyl)benzo-triazole adducts.

The benzotriazole compounds and the benzotriazole segment of the benzotriazole adducts are capable of chelation by the formation of a 6-membered ring with a metallic substrate as illustrated here: 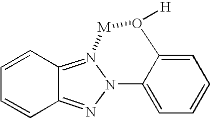
These compounds are also weakly acidic through deprotonation of the phenolic hydroxyl. Both of these properties make them suitable fluxing agents with chemistries that are sensitive to acid.

In those cases where the fluxing agent is the benzotriazole adduct, the electron donor, electron acceptor, or epoxy functionality segment is capable of reacting with the underfill resin to immobilize the benzotriazole, which prevents it from causing voiding during the cure cycle. If acetyl acetonate functionality is present, it performs as an adhesion promoter to metal surfaces, such as solder bumps.

### DETAILED DESCRIPTION OF THE INVENTION

In one embodiment, the benzotriazole used in the fluxing composition will have the structures of the 2-(2-hydroxyphenyl)benzotriazole compounds as described earlier.

In a further embodiment, the benzotriazole fluxing agent used in the fluxing composition will be a benzotriazole adduct having the structure:

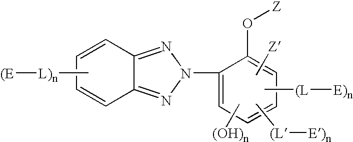

in which n is 0,1,2, or 3; E and E′ independently are an organic moiety containing electron donor, electron acceptor, epoxy, or acetyl acetonate functionality; Z is hydrogen, hydrocarbyl, or an organic moiety containing electron donor, electron acceptor, epoxy, or acetyl acetonate functionality; Z′ is hydrogen, hydrocarbyl, an electron donating group (such as, —OCH₃, phenyl); an electron withdrawing group (such as —NO_{2,} —CN); and L and L′ independently are a direct bond, a hydrocarbyl group, or a functionality selected from the group consisting of.

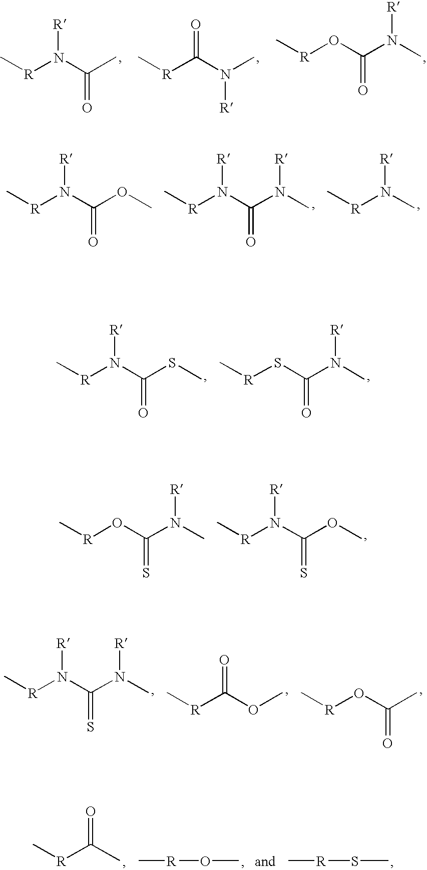

in which R is a direct bond or a hydrocarbyl group attached to the benzotriazole segment, and R′ is hydrogen, an aromatic, or an alkyl group of 1 to 6 carbon atoms, and preferably is hydrogen, methyl or ethyl.

Within this specification and claims, hydrocarbyl group means, for example, a linear or branched alkyl or alkenyl group or a cyclic alkyl or alkenyl group, or an aromatic group. An organic moiety containing an electron donor, electron acceptor, epoxy, vinyl, or acetyl acetonate functionality, means that functionality itself, or that functionality with a hydrocarbyl group.

Exemplary electron donor groups are vinyl ethers, vinyl silanes, compounds containing carbon to carbon double bonds attached to an aromatic ring and conjugated with the unsaturation in the aromatic ring, such as compounds derived from cinnamyl and styrenic starting compounds. Exemplary electron acceptor groups are fumarates, maleates, acrylates, and maleimides.

In another embodiment the benzotriazole adduct will have the structure:

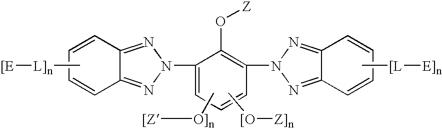

in which n, E, L, Z and Z′ are as described above and at least one of Z and Z′ cannot be hydrogen or alkyl.

The electron donor, electron acceptor, epoxy or acetyl acetonate functionality can be attached to the benzotriazole segment through the 2-hydroxyphenyl ring, through the 2-hydroxyl group itself, or through the benzyl ring of the benzotriazole.

In addition to the electron donor, electron acceptor, epoxy, or acetyl acetonate functionality, the 2-hydroxyphenyl ring may also contain a second organic moiety having a reactive functionality.

An exemplary benzotriazole adduct is 2-(3-(2H-benzotriazol-2-yl)-4-hydroxyphenyl) ethyl methacrylate, (hereinafter Compound B), which is a fine white powder commercially available from Ciba as Tinuvin R 796.

The benzotriazole adduct compounds of this invention, and other benzotriazole adducts having polymerizable segments positioned as the E, E′, Z or Z′ groups in the above structures, are suitable fluxing agents for underfill or fluxing compositions. The amount used in a formulation will be an effective amount to promote fluxing and in general, an effective amount will range from 0.005 to 20.0 percent by weight of the formulation. In addition, such fluxing compositions will contain a curable resin, optionally a curing initiator, and optionally conductive or nonconductive filler.

In one embodiment, the fluxing composition can be used to flux solders in a capillary underfill operation as described in the Background section of this specification. In that case, the fluxing composition will comprise a fluxing agent or a combination of several fluxing agents, a solvent or a combination of several solvents, and optional additives, such as dispersing agents and defoamers.

When used in a capillary flow operation, the thermal stability of the fluxing agent should be sufficient to withstand the elevated temperature at which the solder is reflowed. The solder reflow temperature will depend on the solder composition, and will vary with the actual metallurgy. The practitioner will be able to make the determination of the solder reflow temperature by heating the solder until it reflows. The determination of the thermal stability of the fluxing agent can be readily assessed by thermal gravimetric analysis (TGA), a technique well within the expertise of one skilled in the art.

In another embodiment, the fluxing composition of this invention comprises one or more resins; optionally, one or more curing agents for those resins; and optionally conductive or nonconductive fillers. The curable resin will be present in an amount from 10 to 99.5 weight %; the curing agent, if present, will be present in an amount up to 30 weight %; the fillers, if present, will be present in an amount up to 80 weight %; and the fluxing agent will be present in an amount from 0.5 to 30 weight %.

Suitable resins for the fluxing composition include, but are not limited to, epoxy, electron donor resins (such as, vinyl ethers, vinyl silanes, thiol-enes, and resins that contain carbon to carbon double bonds attached to an aromatic ring and conjugated with the unsaturation in the aromatic ring, such as compounds derived from cinnamyl and styrenic starting compounds), and, electron acceptor resins (such as, fumarates, maleates, acrylates, and maleimides), polyamide, phenoxy, polybenzoxazine, cyanate ester, bismaleimide, polyether sulfone, polyimide, benzoxazine, siliconized olefin, polyolefin, polybenzoxyzole, polyester, polystyrene, polycarbonate, polypropylene, poly(vinyl chloride), polyisobutylene, polyacrylonitrile, poly(methyl methacrylate), poly(vinyl acetate), poly(2-vinylpyridine), cis-1,4-polyisoprene, 3,4-polychloroprene, vinyl copolymer, poly(ethylene oxide), poly(ethylene glycol), polyformaldehyde, polyacetaldehyde, poly(b-propiolacetone), poly(10-decanoate), poly(ethylene terephthalate), polycaprolactam, poly(11-undecanoamide), poly(m-phenylene-terephthalamide), poly(tetramethlyene-m-benzenesulfonamide), polyester polyarylate, poly(phenylene oxide), poly(phenylene sulfide), polysulfone, polyetherketone, polyetherimide, fluorinated polyimide, polyimide siloxane, polyisoindolo-quinazolinedione, polythioetherimide, polyphenylquinoxaline, polyquinixalone, imide-aryl ether phenylquinoxaline copolymer, polyquinoxaline, polybenzimidazole, polybenzoxazole, polynorbornene, poly(arylene ethers), polysilane, parylene, benzocyclobutenes, hydroxy(benzoxazole) copolymer, poly(silarylene siloxanes), and polybenzimidazole.

In one embodiment, the resins include cyanate esters, epoxies, bismaleimides, (meth)acryates, and a combination of one or more of these.

Suitable curing agents are thermal initiators and photoinitiators present in an effective amount to cure the fluxing composition. In general, those amounts will range from 0.5% to 30%, preferably 1% to 20%, by weight of the total organic material (that is, excluding any inorganic fillers) in the formulation. Preferred thermal initiators include peroxides, such as butyl peroctoates and dicumyl peroxide, and azo compounds, such as 2,2′-azobis(2-methyl-propanenitrile) and 2,2′-azobis(2-methyl-butanenitrile). A preferred series of photoinitiators is one sold under the trademark Irgacure by Ciba Specialty Chemicals. In some formulations, both thermal initiation and photoinitiation may be desirable: the curing process can be started either by irradiation, followed by heat, or can be started by heat, followed by irradiation.

In general, the formulations will cure within a temperature range of 70° C. to 250° C., and curing will be effected within a range of ten seconds to three hours. The actual cure profile will vary with the components and can be determined without undue experimentation by the practitioner.

Fluxing compositions typically comprise nonconductive fillers, such as, particles of vermiculite, mica, wollastonite, calcium carbonate, titania, sand, glass, fused silica, fumed silica, barium sulfate, and halogenated ethylene polymers, such as tetrafluoroethylene, trifluoroethylene, vinylidene fluoride, vinyl fluoride, vinylidene chloride, and vinyl chloride. For some purposes, the fluxing compositions may also comprise electrically or thermally conductive fillers, such as, carbon black, graphite, gold, silver, copper, platinum, palladium, nickel, aluminum, silicon carbide, boron nitride, diamond, and alumina. If present, fillers generally will be in amounts of 20% to 90% by weight of the formulation.

The following are synthetic procedures that can be used to make benzotriazole adducts as disclosed in this specification. These procedures, and exemplary adducts, have been previously disclosed in U.S. Pat. No. 6,930,136.

PROCEDURE 1. Reaction of isocyanate with alcohol. One mole equivalent of isocyanate is solvated in toluene in a three-necked flask equipped with a mechanical stirrer, addition funnel and nitrogen inlet/outlet. The reaction is placed under nitrogen and catalytic of dibutyltin dilaurate is added with stirring as the solution is heated to 60° C. The addition funnel is charged with one mole equivalent of alcohol dissolved in toluene. This solution is added to the isocyanate solution over ten minutes, and the resulting mixture is heated for an additional three hours at 60° C. After the reaction is allowed to cool to room temperature, the solvent is removed in vacuo to give the product.

PROCEDURE 2. Reaction of isocyanate with amine. One mole equivalent of isocyanate is solvated in toluene in a three-necked flask equipped with a mechanical stirrer, addition funnel and nitrogen inlet/outlet. The reaction is placed under nitrogen and the solution heated to 60° C. The addition funnel is charged with one mole equivalent of amine in toluene, and this solution is added to the isocyanate solution over ten minutes. The resulting mixture is heated for an additional three hours at 60° C., after which it is allowed to cool to room temperature. The solvent is removed in vacuo to give the product.

PROCEDURE 3. Reaction of alkyl halide with amine or mercaptan. One mole equivalent of alkyl halide is solvated in THF in a three neck flask equipped with a mechanical stirrer and addition funnel. The addition funnel is charged with one mole equivalent of amine or mercaptan in THF and this solution is added to the alkyl halide solution over ten minutes at 0° C. The resulting mixture is stirred for 12 hours at room temperature, after which the solvent is removed in vacuo and ether and water are added to the resulting material. The organic layer is extracted and dried over MgSO₄, and the solvent removed in vacuo to give the product.

PROCEDURE 4. Reaction of alkyl halide with alcohol. One mole equivalent of alcohol, an excess amount of 50% NaOH, a catalytic amount of tetrabutyl ammonium hydrogen sulfate, and one mole equivalent of alkyl halide in toluene are stirred for five hours at 53° C., then for five hours at 75° C. The reaction is allowed to cool to room temperature and the organic layer extracted and washed with brine three times. The isolated organic layer is dried over MgSO₄, filtered, and the solvent removed in vacuo to give the product.

PROCEDURE 5. Conversion of alcohol functionality to chloride functionality. The synthetic procedure is conducted according to E. W. Collington and A. I. Meyers, J. Org. Chem. 36, 3044 (1971). To a stirred mixture of one mole equivalent of alcohol and 1.1 mole equivalent of s-collidine under nitrogen is added one equivalent of lithium chloride dissolved in a minimum amount of dry dimethylformamide. On cooling to 0° C., a suspension is formed and this is treated dropwise with 1.1 mole equivalent of methane-sulfonyl chloride. Stirring is continued at 0° C. for one to one and one-half hour, after which the pale yellow reaction mixture is poured over ice-water. The aqueous layer is extracted with cold ether/pentane (1:1) and the combined extracts are washed successively with saturated copper nitrate solution. This is continued until no further intensification of the blue copper solution occurs, indicating complete removal of s-collidine. The organic extracts are dried over Na₂SO₄ and concentrated at room temperature, providing the product.

PROCEDURE 6. Reaction of amine with acid chloride. One equivalent of amine and one equivalent of triethylamine are mixed in dry methylene chloride at 0° C. One equivalent of acid chloride dissolved in dry methylene chloride is added and the mixture allowed to react for four hours. The solvent is evaporated and the crude product is purified by column chromatography using a gradient of hexane/ethyl acetate to give the product.

PROCEDURE 8. Reaction of alcohol with carboxylic acid. One mole equivalent of carboxylic acid, one mole equivalent of alcohol, and a catalytic amount of sulfuric acid are solvated with toluene in a four-necked flask fitted with a Dean Stark apparatus, mercury thermometer, mechanical stirrer, and an inlet/outlet tube. The reaction mixture is blanketed with nitrogen and the temperature raised to reflux (110° C.). Reflux is maintained for approximately four hours, at which point water (indicating the reaction is progressing) is obtained in the Dean Stark trap along with solvent. The condensate trap is emptied to remove the collected water and toluene and an amount of toluene equal to the amount of water and toluene removed is charged to the flask to maintain a consistent solvent level. Following another 30 minutes of reflux, the trap is again emptied and the reaction flask recharged with fresh solvent to replace the distillate that is removed. This process is repeated four more times to maximize water removal from the system. Following the final 30 minutes of reflux, the heat is removed, the solvent is evaporated, and the crude product is purified by column chromatography using a gradient of hexane/ethyl acetate to give the product.

PROCEDURE 9. Reaction of alcohol with vinyl silane. One mole equivalent of alcohol and triethylamine are mixed in dry toluene at 0° C., to which is added one mole equivalent of vinyl silane dissolved in toluene. The mixture is allowed to react for four hours at room temperature, after which the solvent is evaporated to give the product.

PROCEDURE 10. Reaction of isocyanate with mercaptan. One mole equivalent of isocyanate is solvated in toluene in a three-necked flask equipped with a mechanical stirrer, addition funnel and nitrogen inlet/outlet. The reaction is placed under nitrogen and the solution heated to 60° C. The addition funnel is charged with one mole equivalent of mercaptan in toluene. This solution is added to the isocyanate solution over ten minutes, and the resulting mixture is heated for an additional three hours at 60° C. After the reaction is allowed to cool to room temperature, the solvent is removed in vacuo to give the product.

PROCEDURE 11. Reaction of isothiocyanate with alcohol. One mole equivalent of isothiocyanate is solvated in toluene in a three-necked flask equipped with a mechanical stirrer, addition funnel and nitrogen inlet/outlet. The reaction is placed under nitrogen, and a catalytic amount of dibutyltin dilaurate is added with stirring as the solution is heated to 60° C. The addition funnel is charged with one mole equivalent of alcohol dissolved in toluene, which is added to the isothiocyanate solution over ten minutes. The resulting mixture is heated for an additional three hours at 60° C. After the reaction is allowed to cool to room temperature, the solvent is removed in vacuo to give the product.

PROCEDURE 13. Reaction of carboxylic acid with isocyanate. The synthesis is conducted according to T. Nishikubo, E. Takehara, and A. Kameyama, Polymer Journal, 25, 421 (1993). A stirred mixture of one mole equivalent of isocyanate and one mole equivalent of carboxylic acid is solvated in toluene in a three-necked flask equipped with a mechanical stirrer and nitrogen inlet/outlet. The mixture is heated for two hours at 80° C., and then allowed to cool to room temperature. The solvent removed in vacuo to give the product.

PROCEDURE 14. Reaction of disiloxane with vinyl epoxy. A round-bottomed flask is charged with one mole equivalent of disiloxane and one mole equivalent of vinyl epoxy resin. The reaction flask is equipped with a magnetic stirrer and a reflux condenser. To this mixture is added a catalytic amount of tris(triphenylphosphine)rhodium(I) chloride, and the reaction mixture is heated to 80-85° C. for six hours. The reaction is followed using gas chromatography by monitoring the disappearance of the starting materials and the appearance of the products. After the completion of the reaction, pure product is obtained by fractional vacuum distillation.

PROCEDURE 15. Synthesis of epoxy functional benzotriazole. One mole equivalent of benzotriazole is dissolved in toluene and placed in a two-necked round bottomed flask. One mole equivalent of epoxy siloxane adduct is added to the flask, and the reaction mixture is heated to 60° C. One drop of Karstedt's catalyst is added to initiate the hydrosilation reaction, which is monitored by following the disappearance of Si−H band at 2117 cm⁻¹ in the infrared spectrum. The reaction is over in approximately two to three hours. After cooling, the reaction mixture is poured with stirring into methanol to precipitate the product. The precipitated benzotriazole is washed with methanol and dried in vacuo at 60° C. for eight hours.

PROCEDURE 16. Reaction of phenol or acetoacetate with alkyl or alkenyl halide. One mole equivalent of phenol or acetoacetate is charged to a three-necked flask equipped with a mechanical stirrer, condenser, and inlet/outlet tube for nitrogen. Methyl ethyl ketone is added and the reaction placed under nitrogen gas. Alkyl or alkenyl halide is added through a syringe and stirring initiated. Potassium carbonate is added and the reaction mixture heated at 50° C. for 11 hours, allowed to cool to room temperature, and vacuum filtered. The filtrate is washed with 5% NaOH and 10% Na₂SO₄. The organic layer is dried over MgSO₄, and the solvent evaporated off to give the product.

PROCEDURE 17. Reaction of alcohol or amine with diketene. Alcohol or amine, and acetone and triethylamine are added to a three-necked flask equipped with an addition funnel and magnetic stirrer. The mixture is cooled to 0° C. and diketene in acetone is added to the addition funnel under nitrogen. Diketene is added to the flask over approximately 30 minutes, after which the reaction mixture is stirred at room temperature for five hours. The solvent is removed under reduced pressure and the solid product is ground with mortar and pestle and washed with water in a beaker. The mixture is vacuum filtered and the solid is washed with hexane. This product is placed in an aluminum pan and dried in a vacuum oven to give the product.

PROCEDURE 18. Reaction of phenol with epoxy. An agitated mixture of one mole equivalent of epoxy resin, one mole equivalent of phenolic resin, and 0.4 mole equivalent of tetramethylammonium chloride is heated to 85° C., and maintained at this temperature for a period of 12 hours. Upon being cooled to room temperature, the resulting reaction product partially solidified. The resulting material is recrystallized from methanol-water solution to give the product.

PROCEDURE 19. Reaction of carboxylic acid with epoxy. An agitated mixture of one mole equivalent of epoxy resin, one mole equivalent of carboxylic acid resin, and 0.4 mole equivalent of tetramethylammonium bromide is heated to 80° C., and maintained at this temperature for a period of 10 hours. Upon being cooled to room temperature, the resulting reaction product, which is in the form of a viscous oil, is removed and subjected to a base titration. The resulting material is recrystallized from methanol-water solution to give the product

PROCEDURE 20. Reaction of benzotriazole with alcohol. In a round-bottle flask, one mole equivalent of benzotriazole and one mole equivalent of alcohol are dissloved in 97% sulfuric acid and stirred using a Teflon-coated magnetic stirring bar during 20 hours. The flask is cooled with ice for the first two hours, after which the solution is allowed to come to room temperature. At the end of the reaction, the solution is poured into ice and water to precipitate the product. The suspension is filtered, and the collected crude product washed with water and dried. The crude product is recrystallized from a 1:1 mixture of ethanol-ethyl acetate.

The following are exemplary benzotriazole adducts and synthetic methods for obtaining those compounds.

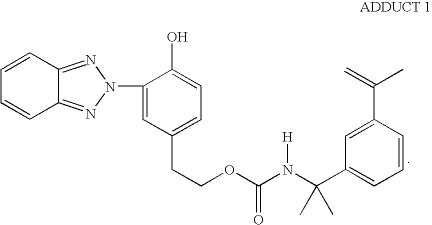

3-lsopropenyl-α,α-dimethylbenzyl isocyanate (m-TMI, 30.0 g, 0.149 mole) was solvated in 50 mL toluene in a 500 mL three-necked flask equipped with a mechanical stirrer, addition funnel and nitrogen inlet/outlet. The reaction was placed under nitrogen, and 0.01 equivalent catalytic dibutyltin dilaurate was added with stirring as the solution heated to 70° C. The addition funnel was charged with 3-(2H-benzotriazole-2-yl)-4-hydroxyphenethyl alcohol (38.1 g, 0.149 mole) dissolved in 50 mL toluene and this was added to the isocyanate solution over ten minutes. The resulting mixture was heated for an additional three hours at 70° C. After the reaction was allowed to cool to room temperature, the mixture was washed with distilled water three times. The isolated organic layer was dried over MgSO₄, filtered, and the solvent removed in vacuo to give the product in 97% yield.

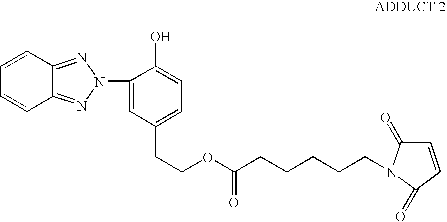

A solution of one mole equivalent of maleic anhydride in acetonitrile was added to a one mole equivalent of 6-aminocaprioc acid in acetic acid. The mixture was allowed to react for three hours at room temperature. The formed white crystals were filtered off, washed with cold acetonitrile and dried to produce the amic acid adduct. The amic acid adduct was mixed with triethylamine in toluene, the mixture heated to 130° C. for two hours and the water of reaction collected in a Dean-Stark trap. The organic solvent was evaporated and 2M HCL added to reach pH 2. The product was extracted with ethyl acetate, and the ethyl acetate solution was dried over MgSO₄. The solvent was evaporated to give 6-maleimidocaproic acid (MCA).

6-Maleimidocaproic acid (MCA, 18.17 g, 0.0861 mole), 3-(2H-benzotriazole-2-yl)-4-hydroxyphenethyl alcohol (20.0 g, 0.0783 mole) and 250 mL toluene were added to a 500 mL three-necked flask and heated to 80° C. until solids were dissolved. Sulfuric acid catalyst (0.384 g) was added and the heat was increased to 140° C. After 11 hours of heating, the water of reaction (1.41 mL) and toluene (25mL) were removed from Dean-Stark apparatus. Fresh toluene (25 mL) was replaced in the flask. This was repeated three times to maximize water removal from the system. Triethyl amine (7.80 mL) was added and the mixture was allowed to stir for one hour at room temperature. NaCl (20%) was added to the mixture and the mixture transfered to a separatory funnel. The organic layer was isolated and dried over MgSO₄ followed by evaporation of the solvent to give the product in 75% yield.

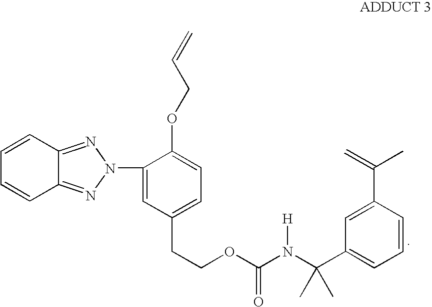

Adduct 1 (10 g, 0.0219 mole) and 80 mL methyl ethyl ketone were added to a 250 mL three-necked flask equipped with a mechanical stirrer and condenser and placed under nitrogen gas. Allyl bromide (7.95 g, 0.066 mole) was added to the flask through a syringe and stirring was initiated. Potassium carbonate was added to the flask and the reaction mixture was heated at 50° C. for 11 hours, after which it was allowed to cool to room temperature and vacuum filtered. The filtrate was washed with 5% NaOH and 10% Na₂SO₄. The organic layer was dried over MgSO₄ followed by evaporation of the solvent to give the product in 65% yield.

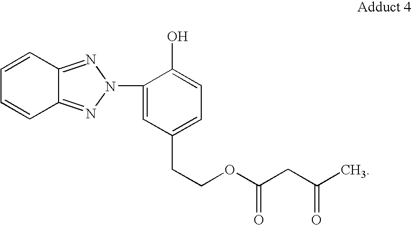

In a 500 mL three-necked flask equipped with an addition funnel and stirrer was added 3-(2H-benzotriazole-2-yl)-4-hydroxyphenethyl alcohol (46.72 g, 0.183 mole), 150 mL reagent grade acetone and triethylamine. The mixture was cooled to 0° C. Diketene (20 g, 0.238 mole) in 20 mL acetone was added to the addition funnel under nitrogen and added to the flask over approximately 30 minutes. The reaction mixture was stirred at room temperature for 5 hours, after which the solvent was removed under reduced pressure. The solid product was ground with mortar and pestle and washed with water in a beaker. The mixture was vacuum filtered and the solid washed with hexane. The product was placed in an aluminum pan and dried in a vacuum oven to give the product in 85% yield.

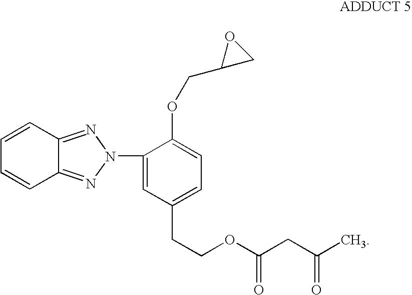

Adduct 5 can be prepared according to Procedure 16 by the reaction of 3-(2H-benzotriazole-2-yl)-4-hydroxyphenethyl alcohol and epichlorohydrin, followed by reaction with diketene according to Procedure 17.

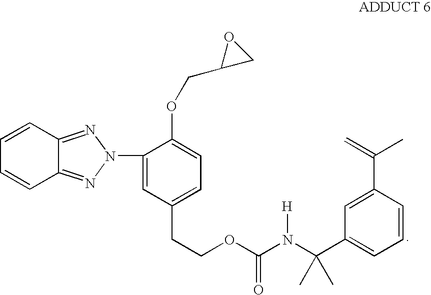

Adduct 6 can be prepared according to Procedure 16 by the reaction of 3-(2H-benzotriazole-2-yl)-4-hydroxyphenethyl alcohol and epichlorohydrin, followed by reaction with m-TMI according to Procedure 1.

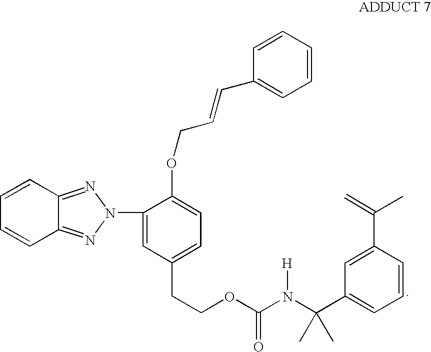

Adduct 7 can be prepared according to Procedure 16 by the reaction of 3-(2H-benzotriazole-2-yl)-4-hydroxy-phenethyl alcohol and cinnamyl chloride, followed by reaction with M-TMI according to Procedure1.

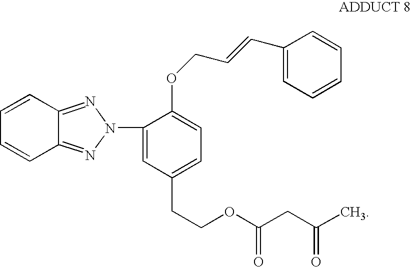

Adduct 8 can be prepared according to Procedure 16 by the reaction of 3-(2H-benzotriazole-2-yl)-4-hydroxy-phenethyl alcohol and cinnamyl chloride, followed by reaction with diketene according to Procedure 17.

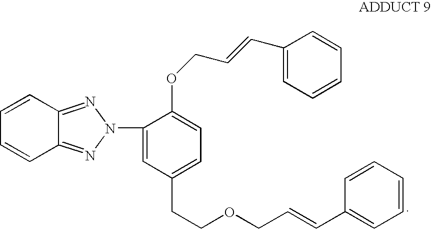

Adduct 9 can be prepared according to Procedure 16 by the reaction of 3-(2H-benzotriazole-2-yl)-4-hydroxy-phenethyl alcohol and cinnamyl chloride, followed by reaction with cinnamyl chloride according to Procedure

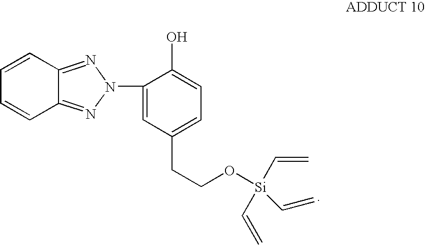

Adduct 10 can be prepared according to Procedure 9 by the reaction of 3-(2H-benzotriazole-2-yl)-4-hydroxyphenethyl alcohol and trivinyl chlorosilane.

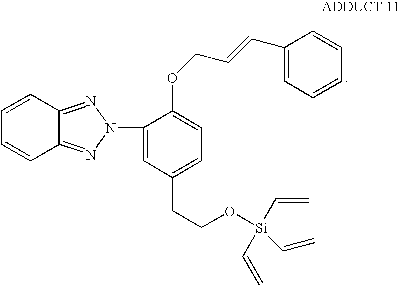

Adduct 11 can be prepared according to Procedure 16 by the reaction of 3-(2H-benzotriazole-2-yl)-4-hydroxy-phenethyl alcohol (BzTz-OHPhEtOH) and cinnamyl chloride, followed by reaction with trivinyl chlorosilane according to Procedure 9.

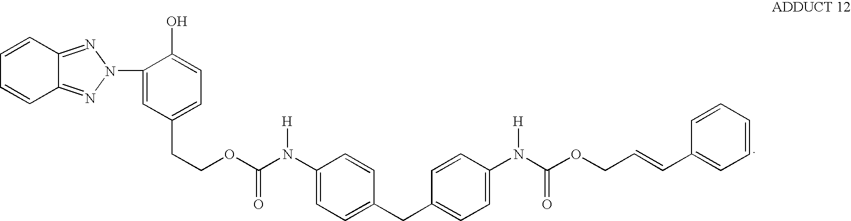

Adduct 12 can be prepared according to Procedure 1 by the reaction of 3-(2H-benzotriazole-2-yl)-4-hydroxyphenethyl alcohol and 4,4′ methylene di(phenylisocyanate) (MDI), followed by reaction with cinnamyl alcohol according to Procedure 1.

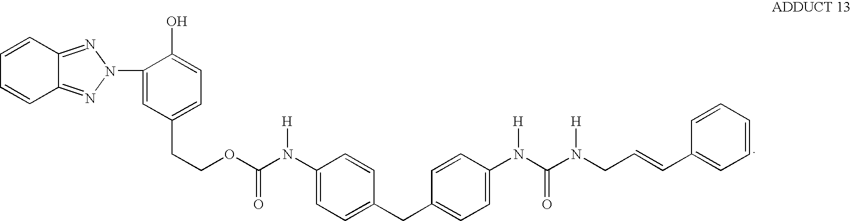

Adduct 13 can be prepared according to Procedure 1 by the reaction of 3-(2H-benzotriazole-2-yl)-4-hydroxyphenethyl alcohol and 4,4′ methylene di(phenylisocyanate) (MDI), followed by reaction with cinnamyl amine according to Procedure 2.

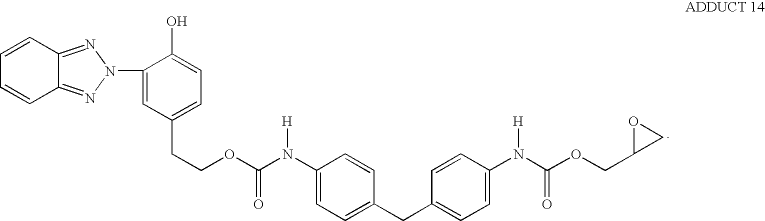

Adduct 14 can be prepared according to Procedure 1 by the reaction of 3-(2H-benzotriazole-2-yl)-4-hydroxyphenethyl alcohol and 4,4′ methylene di(phenylisocyanate) (MDI), followed by reaction with glycidol according to Procedure 1.

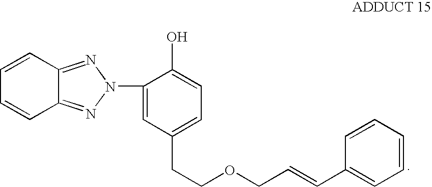

Adduct 15 can be prepared according to Procedure 5 by the reaction of 3-(2H-benzotriazole-2-yl)-4-hydroxyphenethyl alcohol with methyl sulfonyl chloride and lithium chloride, followed by reaction with cinnamyl alcohol according to Procedure 4.

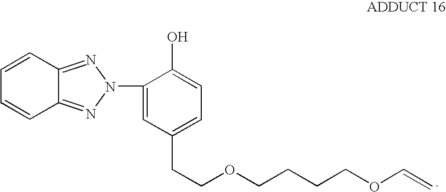

Adduct 16 can be prepared according to Procedure 5 by the reaction of 3-(2H-benzotriazole-2-yl)-4-hydroxyphenethyl alcohol with methyl sulfonyl chloride and lithium chloride, followed by reaction with hydroxybutyl vinyl ether according to Procedure 4.

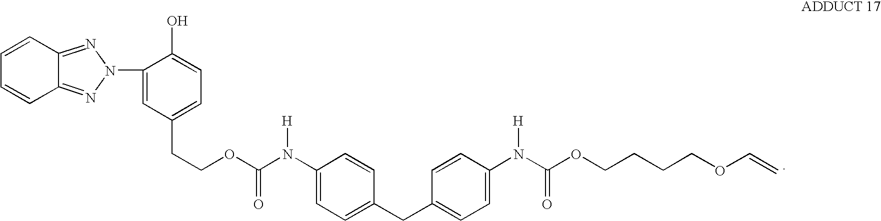

Adduct 17 can be prepared according to Procedure 1 by the reaction of 3-(2H-benzotriazole-2-yl)-4-hydroxyphenethyl alcohol and 4,4′ methylene di(phenylisocyanate) (MDI), followed by reaction with hydroxybutyl vinyl ether according to Procedure 1.

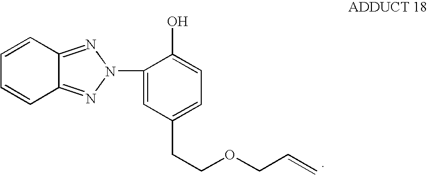

Adduct 18 can be prepared according to Procedure 5 by the reaction of 3-(2H-benzotriazole-2-yl)-4-hydroxyphenethyl alcohol with methyl sulfonyl chloride and lithium chloride, followed by reaction with allyl alcohol according to Procedure 4.

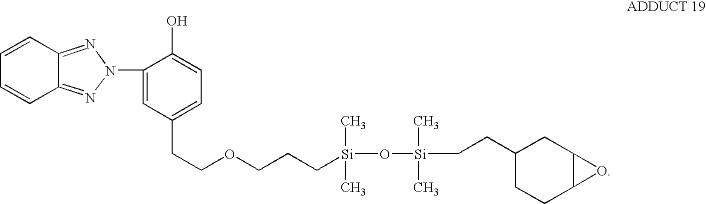

Adduct 19 can be prepared according to Procedure 14 by the reaction of 3-vinyl-7-oxabicyclo[4.1.0]heptane with 1,1,3,3-tetramethyl-disiloxane to give 1-[2-(3[7-oxabicyclo[4.1.0]heptyl])ethyl]-1,1,3,3-tetramethyl-disiloxane, then by the reaction of the benzotriazole adduct 23 according to Procedure 15.

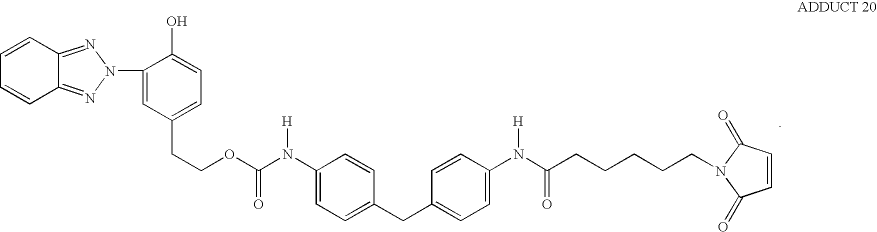

Adduct 20 can be prepared according to Procedure 1 by the reaction of 3-(2H-benzotriazole-2-yl)-4-hydroxyphenethyl alcohol with 4,4′ methylene di(phenylisocyanate) (MDI), followed by reaction with 6-maleimidocaproic acid (synthesis described in Adduct 2) according to Procedure 13.

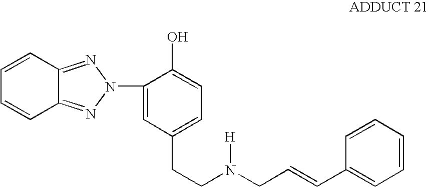

Adduct 21 can be prepared according to Procedure 5 by the reaction of 3-(2H-benzotriazole-2-yl)-4-hydroxyphenethyl alcohol with methyl sulfonyl chloride and lithium chloride, followed by reaction with ammonia according to Procedure 3. The product, which is a primary amine, is reacted with cinnamyl chloride according to Procedure 3.

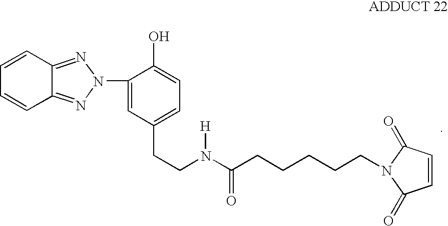

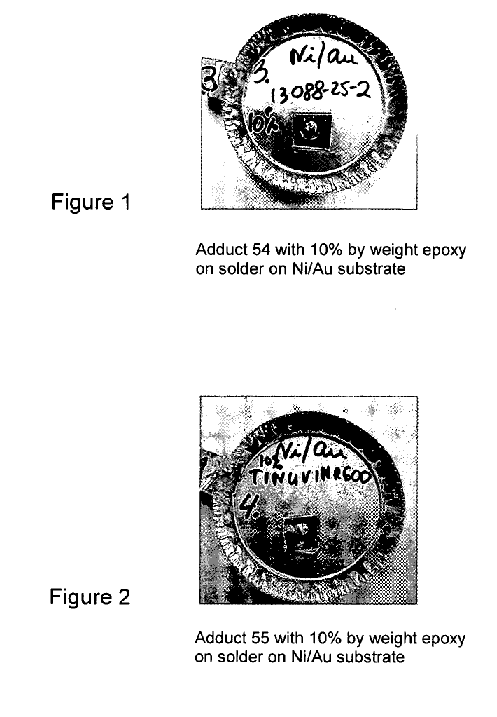

Adduct 22 can be prepared according to Procedure 5 by the reaction of 3-(2H-benzotriazole-2-yl)-4-hydroxyphenethyl alcohol with methyl sulfonyl chloride and lithium chloride, followed by reaction with ammonia according to Procedure 3. The product, which is a primary amine, is reacted with 6-maleimidocaproic acid chloride (prepared from 6-maleimidocaproic acid and thionyl chloride according to Procedure 6) according to Procedure 3. See FIG. 1.

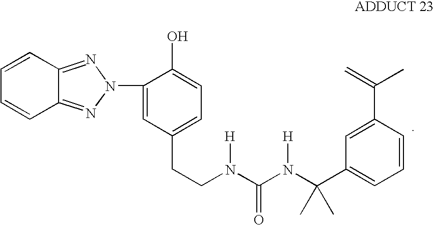

Adduct 23 can be prepared according to Procedure 5 by the reaction of 3-(2H-benzotriazole-2-yl)-4-hydroxyphenethyl alcohol with methyl sulfonyl chloride and lithium chloride, followed by reaction with ammonia according to Procedure 3. The product, which is a primary amine, is reacted with m-TMI according to Procedure 2.

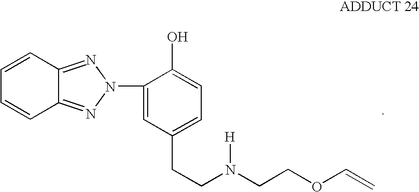

Adduct 24 can be prepared according to Procedure 5 by the reaction of 3-(2H-benzotriazole-2-yl)-4-hydroxyphenethyl alcohol with methyl sulfonyl chloride and lithium chloride, followed by reaction with ammonia according to Procedure 3. The product, which is a primary amine, is reacted with chloroethyl vinyl ether according to Procedure 3.

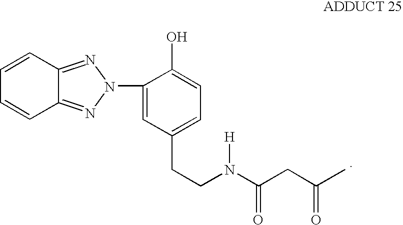

Adduct 25 can be prepared according to Procedure 5 by the reaction of 3-(2H-benzotriazole-2-yI)-4-hydroxyphenethyl alcohol with methyl sulfonyl chloride and lithium chloride, followed by reaction with ammonia according to Procedure 3. The product, which is a primary amine, is reacted with diketene according to Procedure 17.

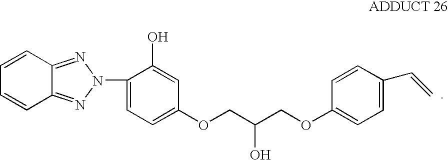

Adduct 26 can be prepared according to Procedure 18 by the reaction of 2-(2,4-dihydroxyphenyl) benzotriazole with [(4-ethenylphenoxy)-methyl]-oxirane.

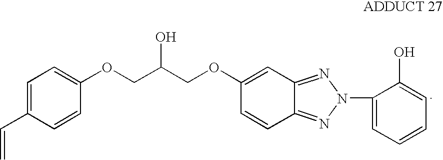

Adduct 27 prepared according to Procedure 18 by the reaction of5-hydoxy-2-(hydroxyphenyl) benzotriazole with [(4-ethenyl-phenoxy) methyl]-oxirane.

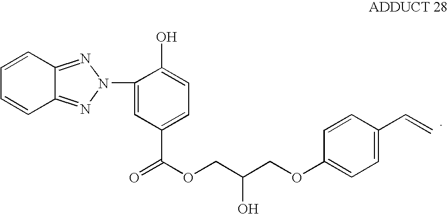

Adduct 28 can be prepared according to Procedure 19 by the reaction of 2-(5-carboxy-2-hydrophenyl) benzotriazole with [(4-ethenyl-phenoxy) methyl]-oxirane.

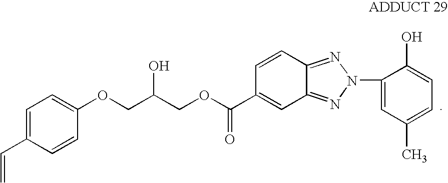

Adduct 29 can be prepared according to Procedure 19 by the reaction of 5-carboxy-2-(5-methyl-2-hydroxyphenyl) benzotriazole with [(4-ethenylphenoxy)methyl]-oxirane.

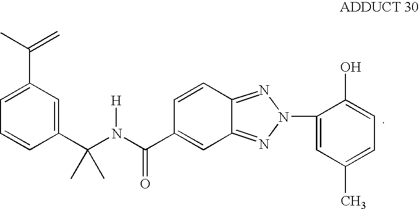

Adduct 30 can be prepared according to Procedure 13 by the reaction of 5-carboxy-2-(5-methyl-2-hydroxyphenyl) benzotriazole with m-TMI.

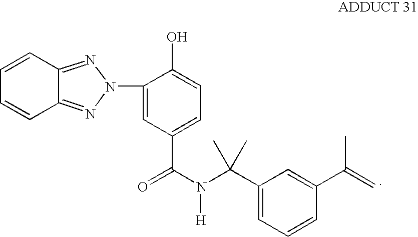

Adduct 31 can be prepared according to Procedure 13 by the reaction of 2-(5-carboxy-2-hydrophenyl) benzotriazole with m-TMI.

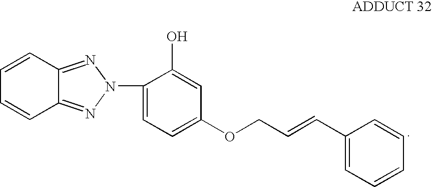

Adduct 32 can be prepared according to Procedure 16 by the reaction of 2-(2,4-dihydroxyphenyl) benzotriazole with cinnamyl chloride.

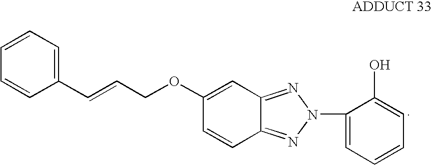

Adduct 33 can be prepared according to Procedure 16 by the reaction of 5-hydroxy-2-(hydroxyphenyl) benzotriazole with cinnamyl chloride.

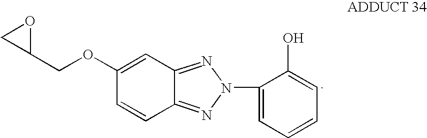

Adduct 34 can be prepared according to Procedure 16 by the reaction of 5-hydoxy-2-(hydroxyphenyl) benzotriazole with epichlorohydrin.

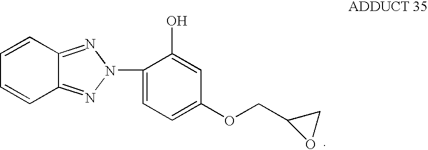

Adduct 35 can be prepared according to Procedure 16 by the reaction of 2-(2,4-dihydroxyphenyl) benzotriazole with epichlorohydrin.

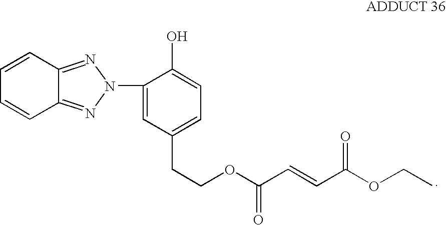

Adduct 36 can be prepared according to Procedure 8 by the reaction of 3-(2H-benzotriazole-2-yl)-4-hydroxyphenethyl alcohol and fumaric acid ethyl ester.

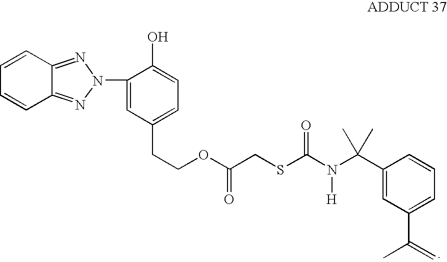

Adduct 37 can be prepared according to Procedure 8 by the reaction of 3-(2H-benzotriazole-2-yl)-4-hydroxyphenethyl alcohol with mercaptoacetic acid, followed by reaction with m-TMI according to Procedure 10.

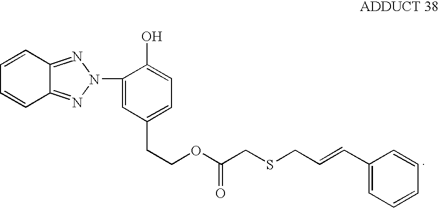

Adduct 38 can be prepared according to Procedure 8 by the reaction of 3-(2H-benzotriazole-2-yl)-4-hydroxyphenethyl alcohol with mercaptoacetic acid, followed by reaction with cinnamyl chloride according to Procedure 3.

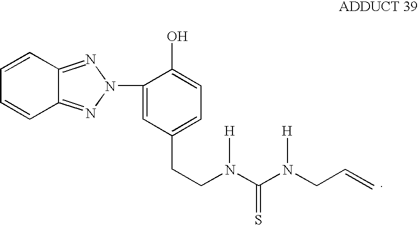

Adduct 39 can be prepared according to Procedure 5 by the reaction of 3-(2H-benzotriazole-2-yl)-4-hydroxyphenethyl alcohol with methyl sulfonyl chloride and lithium chloride, followed by reaction with ammonia according to Procedure 3. The product, which is a primary amine, is reacted with allylisothiocyanate according to Procedure 11.

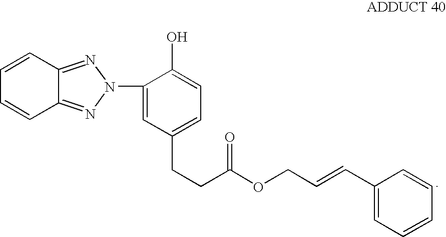

Adduct 40 can be prepared according to Procedure 8 by the reaction of 2-[2-hydroxy-5-(2-carboxyethyl)phenyl]-2H-benzotriazole (prepared according to L. Stoeber, A. Sustic, W. J. Simonsick, and O. Vogl, J.M.S. -Pure Appl. Chem., A37(9), 943, 2000) with cinnamyl alcohol.

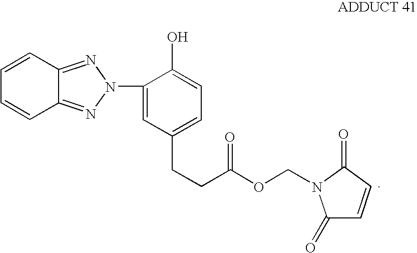

Adduct 41 can be prepared according to Procedure 8 by the reaction of 2-[2-hydroxy-5-(2-carboxyethyl)phenyl]-2H-benzotriazole (prepared according to L. Stoeber, A. Sustic, W. J. Simonsick, and O. Vogl, J.M.S. -Pure Appl. Chem., A37(9), 943, 2000) with N-methylolmaleimide (prepared according to J. Bartus, W. L. Simonsick, and O. Vogl, J.M.S. -Pure Appl. Chem., A36(3), 355, 1999).

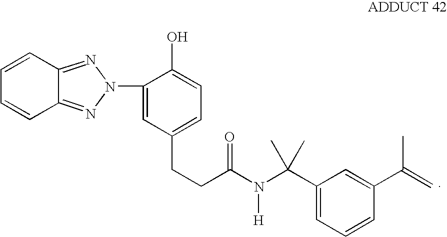

Adduct 42 can be prepared according to Procedure 13 by the reaction of 2-[2-hydroxy-5-(2-carboxyethyl)phenyl]-2H-benzotriazole (prepared according to L. Stoeber, A. Sustic, W. J. Simonsick, and O. Vogl, J.M.S. -Pure Appl. Chem., A37(9), 943, 2000) with m-TMI.

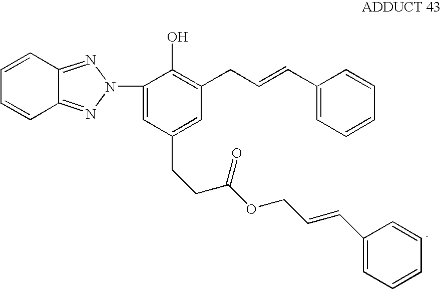

Adduct 43 can be prepared according to Procedure 20 by the reaction of 2-[2-hydroxy-5-(2-carboxyethyl)phenyl]-2H-benzotriazole (prepared according to L. Stoeber, A. Sustic, W. J. Simonsick, and O. Vogl, J.M.S. -Pure Appl. Chem., A37(9), 943, 2000) with cinnamyl alcohol, followed by reaction with another molecule of cinnamyl alcohol according to Procedure

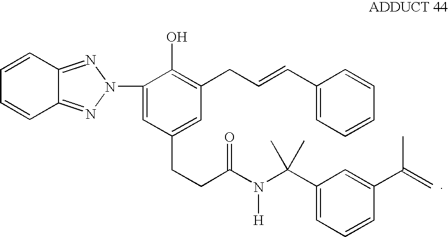

Adduct 44 can be prepared according to Procedure 20 by the reaction of 2-[2-hydroxy-5-(2-carboxyethyl)phenyl]-2H-benzotriazole (prepared according to L. Stoeber, A. Sustic, W. J. Simonsick, and O. Vogl, J.M.S. -Pure Appl. Chem., A37(9), 943, 2000) with cinnamyl alcohol, followed by reaction with m-TMI according to Procedure 13.

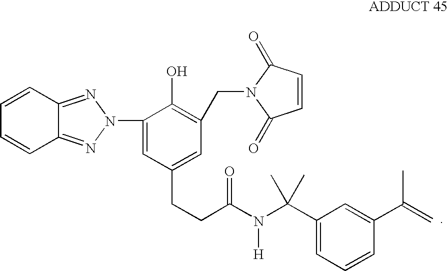

Adduct 45 can be prepared according to Procedure 20 by the reaction of 2-[2-hydroxy-5-(2-carboxyethyl)phenyl]-2H-benzotriazole (prepared according to L. Stoeber, A. Sustic, W. J. Simonsick, and O. Vogl, J.M.S. -Pure Appl. Chem., A37(9), 943, 2000) with N-methylolmaleimide, followed by reaction with m-TMI according to Procedure 13.

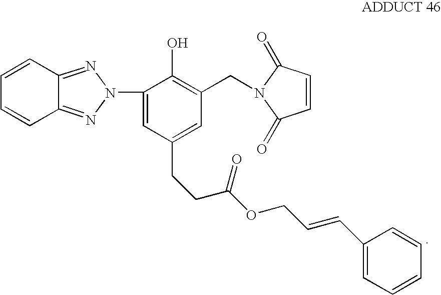

Adduct 46 can be prepared according to Procedure 20 by the reaction of 2-[2-hydroxy-5-(2-carboxyethyl)phenyl]-2H-benzotriazole (prepared according to L. Stoeber, A. Sustic, W. J. Simonsick, and O. Vogl, J.M.S. -Pure Appl. Chem., A37(9), 943, 2000) with N-methylolmaleimide, followed by reaction with cinnamyl alcohol according to Procedure 8.

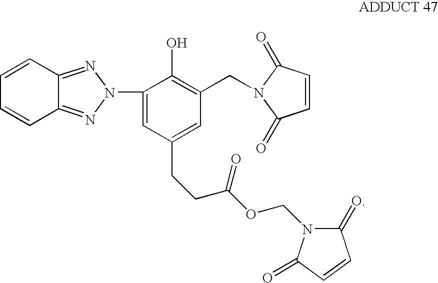

Adduct 47 can be prepared according to Procedure 20 by the reaction of 2-[2-hydroxy-5-(2-carboxyethyl)phenyl]-2H-benzotriazole (prepared according to L. Stoeber, A. Sustic, W. J. Simonsick, and O. Vogl, J.M.S. -Pure Appl. Chem., A37(9), 943, 2000) with N-methylolmaleimide, followed by reaction with another molecule of N-methylolmaleimide according to Procedure 8.

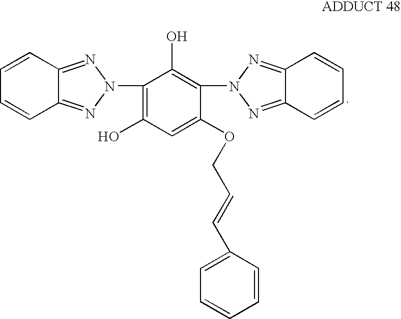

Adduct 48 can be prepared according to Procedure 16 by the reaction of 2-(2,4,6-trihydroxyphenyl)-1,3-di-(2H-benzotriazole) (prepared according to S. Li and O. Vogl, Polymer Bulletin, 12, 375,1984) with cinnamyl chloride.

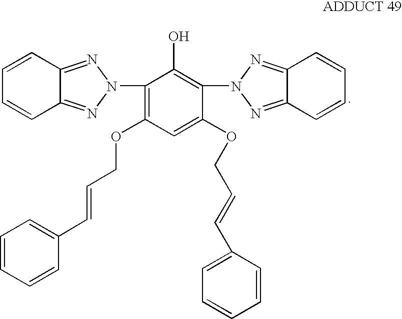

Adduct 49 can be prepared according to Procedure 16 by the reaction of 2-(2,4,6-trihydroxyphenyl)-1,3-di-(2H-benzotriazole) (prepared according to S. Li and O. Vogl, Polymer Bulletin, 12, 375,1984) with cinnamyl chloride.

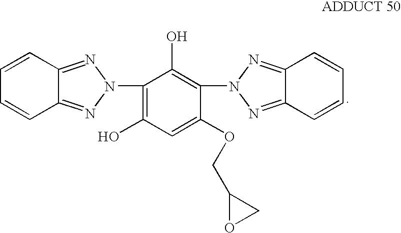

Adduct 50 can be prepared according to Procedure 16 by the reaction of 2-(2,4,6-trihydroxyphenyl)-1,3-di-(2H-benzotriazole) (prepared according to S. Li and O. Vogl, Polymer Bulletin, 12, 375, 1984) with epichlorohydrin.

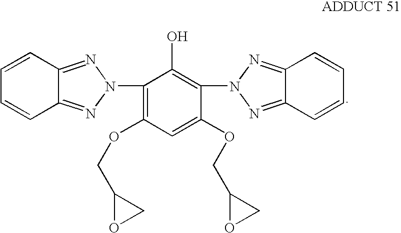

Adduct 51 can be prepared according to Procedure 16 by the reaction of 2-(2,4,6-trihydroxyphenyl)-1,3-di-(2H-benzotriazole) (prepared according to S. Li and O. Vogl, Polymer Bulletin, 12, 375,1984) with epichlorohydrin.

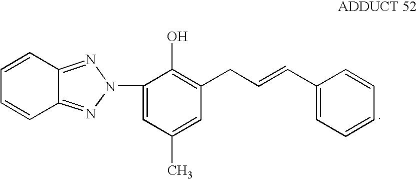

Adduct 52 can be prepared according to procedure 20 by the reaction of 2-(2-hydroxy-5-methylphenyl)-2H-benzotriazole with cinnamyl alcohol.

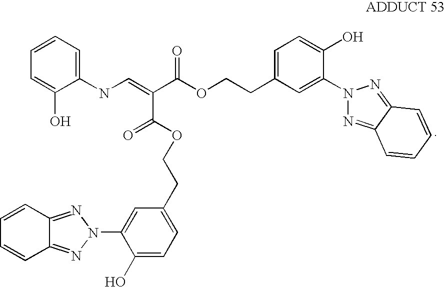

Adduct 53 was prepared as follows: A 250 mL 4-neck round-ottom flask was equipped with a mechanical stirrer, reflux condenser, Dean Stark trap, and slow-addition funnel. The flask was charged with the di-acid having the structure 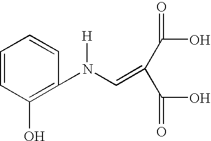
(6.2 g, 0.0222 mol), 3-(2H-benzotri-azole-2-yl)-4-hydroxyphenethyl alcohol (11.32 g, 0.0444 mol), p-toluene sulfonic acid monohydrate (0.43 g, 0.0022 mol) and toluene (50 mL). The slow-addition funnel was filled with 125 mL additional toluene and mounted on the flask. With mixing, the charged reaction flask was placed in an oil bath preheated to 140° C. After three minutes, the thick reaction mixture changed to a dark brown solution and within ten minutes of heating, solvent started distilling into the Dean-Stark trap. Over the course of five hours of refluxing, the trap was emptied five times and each time 25 mL of fresh toluene was charged to the flask. During this time, light colored solids precipitated from the reaction solution, eventually forming a light yellow slurry. Extra toluene was added periodically to maintain refluxing as the reaction mixture grew thicker. Following the five hours of refluxing, the reaction was stopped and the solids were filtered from the mix and collected. Acetone (250 mL) was then combined with the solids in a reaction flask and the resulting mixture was stirred mechanically for 30 minutes. Once again, the solids were filtered from the mix and collected. The acetone wash was repeated twice more. By the final wash, the acetone filtrate had changed from hazy gold to a clear and colorless solution. The resulting ivory white solids were then rinsed with hexane, collected by filtration and dried over night in a vacuum oven at 70° C. The structure and purity of this transesterification adduct was confirmed by ¹H NMR. The ivory white granules were obtained in 65% yield.

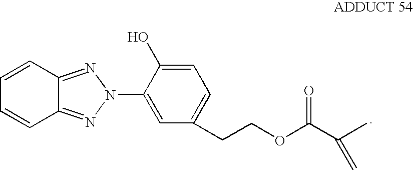

Adduct 54, 2-(3-(2H-benzotriazol-2-yl)-4-hydroxyphenyl) ethyl methacrylate, is commercially available from Ciba as Tinuvin R 796.

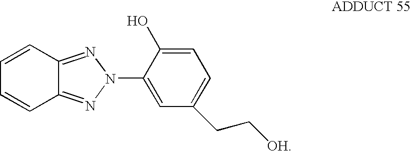

Adduct 55, 3-(2H-benzotri-azole-2-yl)-4-hydroxyphenethyl alcohol, is commercially available from Ciba as Tinuvin R 600

### PERFORMANCE EXAMPLE

In this example, Adducts 2, 54, and 55 were tested for performance as fluxes applied directly to solder, as would be done prior to a capillary flow operation. Performance was measured as the ability of the fluxing agent to collapse a solder ball. Copper or nickel/gold-plated copper coupons were used as substrates and were preheated on a hot plate to 240° C. (a temperature higher than the melting point of the solder). Five to ten mg of fluxing agent were dropped onto the heated hot plate, and then four to six granules of solder, enough to make a solder ball, were dropped onto the fluxing agent. When a solder ball starts to flux, it rapidly collapses and merges into a solder glob that displays a shiny surface. Adducts 54 and 55 were tested on solder on copper coupons; adducts 54 and 55 also were tested with 10% by weight epoxy on solder on Ni/Au coupons; and adduct 2 was tested on solder on nickel/gold coupons. The fluxing reaction was observed on all the examples tested and the time elapsed before the solder ball collapsed was under 30 seconds in each case. FIGS. 1 and 2 show the fluxing of adducts 54 and 55 with the epoxy on Ni/Au coupons.

What is claimed:

1. A fluxing composition comprising a fluxing agent, in which the fluxing agent is a 2-(2-hydroxyphenyl)benzotriazole or a 2-(2-hydroxyphenyl)-benzotriazole adduct.

2. The fluxing composition according to claim 1 in which the 2-(2-hydroxyphenyl)-benzotriazole adduct has the structure: 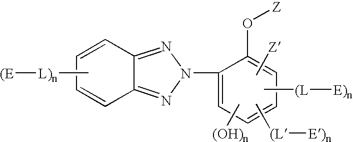
in which
n is 0, 1, 2,or 3;
E and E′ independently are an organic moiety containing electron donor, epoxy, acetyl acetonate, or electron acceptor functionality;
Z is hydrogen, hydrocarbyl, or an organic moiety containing electron donor, epoxy, acetyl acetonate, or electron acceptor, functionality;
Z′ is hydrogen, hydrocarbyl, an electron donating group, or an electron withdrawing group,
L and L′ independently are a direct bond, a hydrocarbyl group, or a functionality selected from the group consisting of. 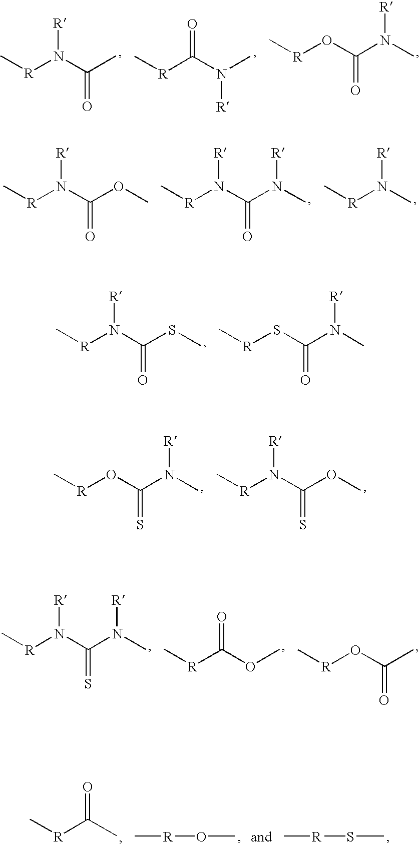
in which R is a direct bond or a hydrocarbyl group attached to the benzotriazole segment; and R′ is hydrogen, an aromatic, or an alkyl group of 1 to 6 carbon atoms.

3. The fluxing composition according to claim 2 in which the benzotriazole adduct has the structure:

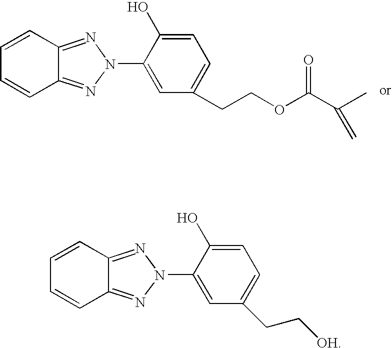

4. The fluxing composition according to claim 2 in which the benzotriazole adduct has the structure:

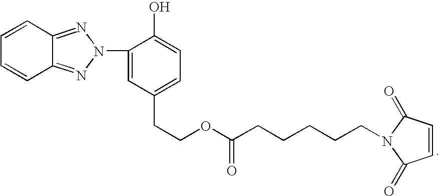

5. The fluxing composition according to claim 1 in which the benzotriazole adduct has the structure: 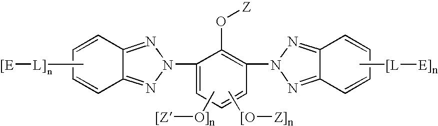
in which
n is 0, 1, 2, or 3;
E and E′ independently are an organic moiety containing electron donor, epoxy, acetyl acetonate, or electron acceptor functionality;
Z is hydrogen, hydrocarbyl, or an organic moiety containing electron donor, epoxy, acetyl acetonate, or electron acceptor excluding acrylate, functionality;
Z′ is hydrogen, hydrocarbyl, an electron donating group, or an electron withdrawing group,
at least one of Z and Z′ cannot be hydrogen or alkyl;
L and L′ independently are a direct bond, a hydrocarbyl group, or a functionality selected from the group consisting of. 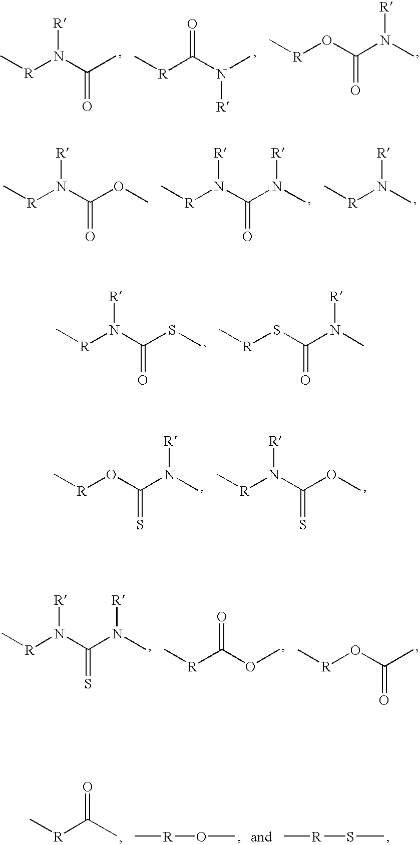
in which in which R is a direct bond or a hydrocarbyl group attached to the benzotriazole segment; and R′ is hydrogen, an aromatic, or an alkyl group of 1 to 6 carbon atoms.
